(19) United States
(12) Patent Application Publication
(10) Pub. No.: US 2020/0128627 A1
(43) Pub. Date: Apr. 23, 2020

(54) STRETCHABLE PRINTED HEATERS FOR WEARABLES AND OTHER ARTICLES

(71) Applicant: E I DU PONT DE NEMOURS AND COMPANY, Wilmington, DE (US)

(72) Inventors: MARK ALLAN LAMONTIA, LANDENBERG, PA (US); MEHRDAD MEHDIZADEH, AVONDALE, PA (US); MOBIN YAHYAZADEHFAR, WEST, PA (US)

(21) Appl. No.: 16/166,726

(22) Filed: Oct. 22, 2018

(51) Int. Cl. H05B 3/34; H05B 3/02; H05B 3/12

(52) U.S. Cl. CPC H05B 3/342; H05B 3/02; H05B 3/12; H05B 2203/003; H05B 2203/013; H05B 2203/036; H05B 2203/004; A41D 2400/22

(57) ABSTRACT

Heater design plays an important role in determining the stretchability of a heater and this invention provides several configurations that improve stretchability. In some of these configurations the use of bus bars with wavelike form, an undulating conductor, provides good stretchability in all directions. In some configurations, slits can be cut in the substrate to further accommodate stretching and improve breathability.

### FIELD OF THE INVENTION

This invention is directed to stretchable printed heaters for wearable garments and other articles.

### BACKGROUND OF THE INVENTION

There is increasing interest in providing comfortable heated wearable garments. Printed heaters for wearables must be stretchable to accommodate wearing, folding, handling, washing, and drying. The polymer thick film pastes used to print the heater, the substrate upon which it is printed, as well as the heater design determine the degree of stretchability. There is a need for heater designs which increase stretchability.

### SUMMARY OF THE INVENTION

This invention is related to printed heater designs that provide stretchable printed heaters.

In one embodiment, this invention provides an article containing a stretchable printed heater, the heater comprising:
a) a substrate;
b) two parallel printed bus bars;
c) an array of printed resistive material areas with uniform thickness arranged along a series of regular zigzags between the two bus bars, wherein each of the essentially same-shaped zigzags can be generated by a repeated application of a glide reflection of a line segment of length L making an angle θ less than 90° with one of the bus bars, wherein a printed resistive material area is situated along each line segment, wherein the length I of each printed resistive material area is shorter than L so that there is a space between adjacent printed resistive material areas, wherein in each zigzag the resistive material area adjacent to the one bus bar is in electrical contact with that bus bar and the resistive material area adjacent to the other bus bar is in electrical contact with that bus bar, and wherein the zigzags are parallel to one another and there is a space between adjacent zigzags; and
d) an array of printed conductive material areas, wherein in each of the zigzags a printed conductive material area is positioned to fill the space between, to overlap, to be contiguous to and provide electrical contact with adjacent pairs of resistive material areas, and wherein the conductive material areas and the bus bars can be printed onto the substrate before or after the resistive material areas.

In another embodiment, this invention provides an article containing a stretchable printed heater, the heater comprising:
a) a substrate;
b) two parallel printed bus bars;
c) an array of printed resistive material areas in the form of serpentines with uniform thickness arranged on parallel paths between the two bus bars with a space between adjacent parallel paths, wherein the parallel paths are not perpendicular to the bus bars, wherein all printed resistive material serpentines on a path have the same orientation, wherein there is a space between adjacent printed resistive material serpentines on a path; and wherein in each path the printed resistive material serpentine adjacent to the one bus bar is in electrical contact with that bus bar and the printed resistive material serpentine adjacent to the other bus bar is in electrical contact with that bus bar; and
d) an array of printed conductive material areas, wherein in each path of printed resistive material serpentines a printed conductive material area is positioned to fill the space between, to overlap, to be contiguous to and provide electrical contact with adjacent pairs of printed resistive material serpentines, and wherein the conductive material areas and the bus bars can be printed onto the substrate before or after the resistive material areas.

In a further embodiment, this invention provides an article containing a stretchable printed heater, the heater comprising:
a) a substrate;
b) two parallel printed bus bars;
c) an array of printed resistive material areas in the form of serpentines with uniform thickness arranged on parallel paths between the two bus bars with a space between adjacent parallel paths, wherein each of the serpentines on a path can be generated by a repeated application of a glide reflection of a serpentine, wherein there is a space between adjacent printed resistive material serpentines on a path; and wherein in each path the printed resistive material serpentine adjacent to the one bus bar is in electrical contact with that bus bar and the printed resistive material serpentine adjacent to the other bus bar is in electrical contact with that bus bar; and
d) an array of printed conductive material areas, wherein in each path of printed resistive material serpentines a printed conductive material area is positioned to fill the space between, to overlap, to be contiguous to and provide electrical contact with adjacent pairs of printed resistive material serpentines, and wherein the conductive material areas and the bus bars can be printed onto the substrate before or after the resistive material areas.

In still another embodiment, this invention provides an article containing a stretchable printed heater, the heater comprising:
a) a substrate;
b) two parallel printed bus bars;
c) an array of printed resistive material areas in the form of essentially identical rectangles of uniform thickness arranged in a criss-cross latticework pattern of intersecting straight lines between the two bus bars, wherein a printed resistive material rectangle is situated along each segment of the criss-cross latticework between intersections of the straight lines, wherein there is a space between adjacent printed resistive material rectangles at each intersection and wherein the resistive material rectangles adjacent to the one bus bar are in electrical contact with that bus bar and the resistive material rectangles adjacent to the other bus bar are in electrical contact with that bus bar; and
d) an array of printed conductive material areas, wherein a printed conductive material area is positioned to fill the space between, to overlap, to be contiguous to and provide electrical contact with all four adjacent resistive material rectangles at every intersection, and wherein the conductive material areas and the bus bars can be printed onto the substrate before or after the resistive material rectangles.

### BRIEF DESCRIPTION OF THE FIGURES

FIG. 1 illustrates an embodiment of a stretchable printed zigzag configuration heater, the heater comprising a substrate with two bus bars, an array of printed resistive material rectangles arranged along a series of regular zigzags between the two bus bars with spaces between adjacent resistive material rectangles in a zigzag and an array of printed electrically conductive rectangles with a conductive rectangle positioned to fill the space between, to overlap, to be contiguous to and provide electrical contact with every adjacent pair of resistive material rectangles.

FIG. 2 illustrates another embodiment of the stretchable printed zigzag configuration heater, wherein the conductive areas are squares and are rotated 45 degrees from the orientation of the conductive rectangles of FIG. 1 to provide better current flow.

FIG. 3 illustrates a section of embodiment of a stretchable simple serpentine printed heater, the heater comprising a substrate with two bus bars, an array of printed resistive material areas in the form of essentially identical serpentines arranged with the same orientation along parallel paths between the two bus bars with spaces between adjacent resistive material serpentines in a path and an array of printed electrically conductive squares with a conductive square positioned to fill the space between, to overlap, to be contiguous to and provide electrical contact with every adjacent pair of resistive material serpentines.

FIG. 4 illustrates a section of another embodiment of a stretchable simple serpentine printed heater, wherein the bus bars are undulating bus bars.

FIG. 5 illustrates a section of an embodiment of a stretchable printed glide reflection serpentine heater, the heater comprising a substrate with two bus bars, an array of printed resistive material serpentines arranged with alternating orientation along parallel paths between the two bus bars with spaces between adjacent resistive material serpentines in a path and an array of printed electrically conductive squares with a conductive square positioned to fill the space between, to overlap, to be contiguous to and provide electrical contact with every adjacent pair of resistive material serpentines.

FIG. 6 illustrates a section of an embodiment of a stretchable printed criss-cross latticework heater, the heater comprising a substrate with two bus bars, an array of printed resistive material rectangles arranged in a criss-cross latticework pattern of intersecting lines between the two bus bars with spaces between adjacent printed resistive material rectangles and an array of printed electrically conductive rectangles with a conductive rectangle positioned to fill the space between, to overlap, to be contiguous to and provide electrical contact with every adjacent pair of resistive material rectangles.

### DETAILED DESCRIPTION OF THE INVENTION

The invention relates to stretchable printed heaters that can be used to heat a variety of articles. The issues with printing large areas of resistive material is resolved by using an array of small areas of resistive material each of which serves as an individual heater instead of a single heater with a large area resistive material layer. The ability to print numerous smaller areas of resistive material results in more uniform areas of resistive material and therefore improved performance of the individual heaters and the heater comprising these individual heaters. The articles include wearable garments, seats and parts of electric automobiles.

In addition, when the substrate upon which the heater is printed is permeable, the heater has the additional advantage of being breathable in the sense that air and moisture, i.e., water vapor, can pass through the exposed regions of the permeable substrate in the separations between adjacent columns. This can provide additional comfort to the wearer of a garment containing the heater since the breathability allows moisture vapor transport and carries perspiration away from the body. The wearable garment itself may be comprised of a permeable fabric upon which the heater is printed or the heater may be printed on a permeable polymer or permeable fabric substrate that is attached to the garment. As used herein, substrate is used to indicate both of these possibilities, the fabric of the article and an attachment to the article. Openings can be made in the regions of the exposed substrate not covered by printed heater components to provide additional breathability if the substrate is permeable or to provide breathability if the substrate is not permeable and to enhance the stretchability of the heater.

Heater design plays an important role in determining the stretchability of the heater and this invention provides several configurations that improve stretchability.

In some embodiments, the screen printed conductive areas and bus bars are silver areas and silver bus bars and the screen printed resistive material is carbon. In other embodiments, the printed conductive areas and bus bars are copper areas and copper bus bars and the printed layer of resistive material is carbon. In still other embodiments, the printed conductive areas and bus bars are silver/silver chloride, gold or aluminum.

The electrically conductive areas and bus bars referred to herein are formed from polymer thick film pastes containing an electrical conductor. These pastes are typically screen-printed onto the substrate. When the printed conductive areas and bus bars are silver, they are formed using polymer thick film silver pastes. The resistive material is also printed using a polymer thick film paste. When the printed resistive material is printed carbon, it is formed using a polymer thick film carbon paste. When using polymer thick film pastes, the polymer is an integral part of the final composition, i.e., the conductive material, the bus bar or the resistive material.

To ease the tolerance in printing it is beneficial to have the width of the conductive area exceed the width of the contiguous resistive material areas.

Polymer thick film pastes designed for stretchable applications provide heaters with improved stretchability.

As used herein, “two bus bars” is used to refer to printed conductors that connect to and provide voltages to the printed resistive material. There are two bus bars for each heater with a voltage applied across them. In some embodiments, it may be convenient to divide a bus bar into separate portions. Such embodiments are included in the “two bus bars” usage.

### Zigzag Configuration

In this configuration, the heater comprises a substrate, two parallel printed bus bars and an array of printed resistive material areas with uniform thickness arranged along a series of regular zigzags between the two bus bars. The zigzags are parallel to one another and there is a space between adjacent zigzags. Each of the essentially same-shaped zigzags can be generated by a repeated application of a glide reflection of a line segment of length L making an angle a less than 90° with one of the bus bars. This zigzag has the form of a portion of a triangle wave. A printed resistive material area is situated along each line segment, wherein the length I of each printed resistive material area is shorter than L so that there is a space between adjacent printed resistive material areas along the zigzag. In each zigzag, the resistive material area adjacent to the one bus bar is in electrical contact with that bus bar and the resistive material area adjacent to the other bus bar is in electrical contact with that bus bar. The zigzags are parallel to each other and there is a space between adjacent zigzags. The heater also comprises an array of printed conductive material areas, wherein in each of the zigzags a printed conductive material area is positioned to fill the space between, to overlap, to be contiguous to and provide electrical contact with adjacent pairs of resistive material areas. The conductive material areas and the bus bars can be printed onto the substrate before or after the resistive material areas.

In one embodiment, the resistive material areas are in the form of essentially identical rectangles. In one embodiment, the conductive material areas are in the form of essentially identical rectangles. In another embodiment, the conductive material areas are in the form of essentially identical squares.

The portions of the resistive material not in contact with the conductive areas or the bus bars provide the heating.

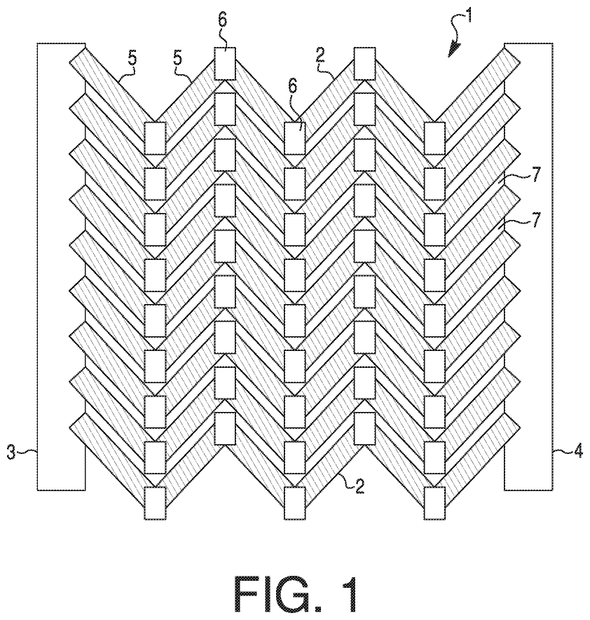

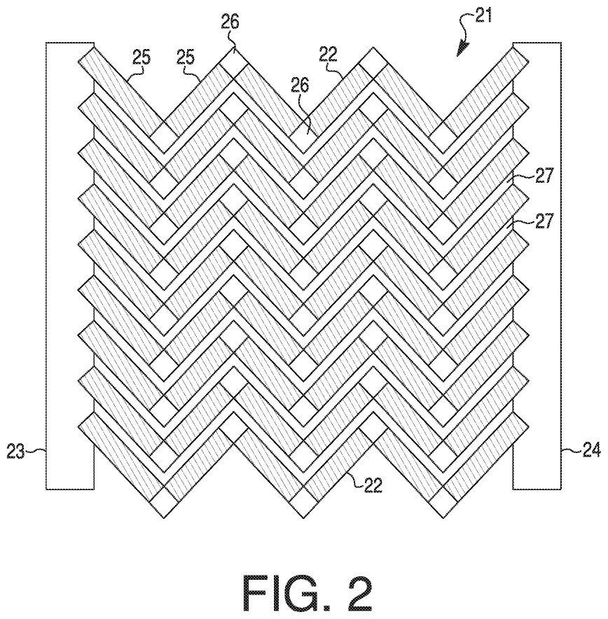

This configuration will be discussed further with reference to FIGS. 1 and 2.

FIG. 1 illustrates an embodiment of a stretchable printed zigzag configuration heater 1 described above. The nine rows of regular zigzags 2 are parallel. There are two printed bus bars 3 and 4. There is an array of printed resistive material areas in the form of resistive material rectangles 5 arranged with uniform spacing along the zigzag. There is one resistive material rectangle 5 along each line segment of the zigzag and spaces between adjacent resistive material rectangles along a zigzag. A conductive rectangle 6 is positioned to fill the space between, to overlap, to be contiguous to and provide electrical contact to every adjacent pair of resistive material rectangles in a zigzag. The spaces 7 of exposed substrate between adjacent zigzags are the same size. The heater provides stretchability in the direction perpendicular to the two bus bars and in oblique directions.

FIG. 2 illustrates another embodiment of the stretchable printed zigzag configuration heater 21, wherein the conductive areas are squares and are rotated 45 degrees from the orientation of the conductive areas of FIG. 1 to provide better current flow. The nine rows of regular zigzags 22 are parallel. There are two printed bus bars 23 and 24. There is an array of printed resistive material areas in the form of resistive material rectangles 25 arranged with uniform spacing along the zigzag. There is one resistive material rectangle 25 along each line segment of the zigzag and spaces between adjacent resistive material rectangles along a zigzag. A conductive square 26 is positioned to fill the space between, to overlap, to be contiguous to and provide electrical contact to every adjacent pair of resistive material rectangles in a zigzag. The spaces 27 of exposed substrate between adjacent zigzags are the same size. The heater provides stretchability in the direction perpendicular to the two bus bars.

### Simple Serpentine Configuration

In this configuration, the heater comprises a substrate, two parallel printed bus bar and an array of printed resistive material areas in the form of serpentines with uniform thickness arranged on parallel paths between the two bus bars with a space between adjacent parallel paths. A serpentine has a curved shape suggestive of a snake. The parallel paths are not perpendicular to the bus bars but make an angle θ with the bus bars. All printed resistive material serpentines on a path have the same orientation. There is a space between adjacent printed resistive material serpentines on a path. In each path, the printed resistive material serpentine adjacent to the one bus bar is in electrical contact with that bus bar and the printed resistive material serpentine adjacent to the other bus bar is in electrical contact with that bus bar. The heater also comprises an array of printed conductive material areas, wherein in each path of printed resistive material serpentines a printed conductive material area is positioned to fill the space between, to overlap, to be contiguous to and provide electrical contact with adjacent pairs of printed resistive material serpentines. The conductive material areas and the bus bars can be printed onto the substrate before or after the resistive material. In one embodiment, the resistive material areas are in the form of essentially identical serpentines.

The portions of the resistive material not in contact with the conductive areas or the bus bars provide the heating.

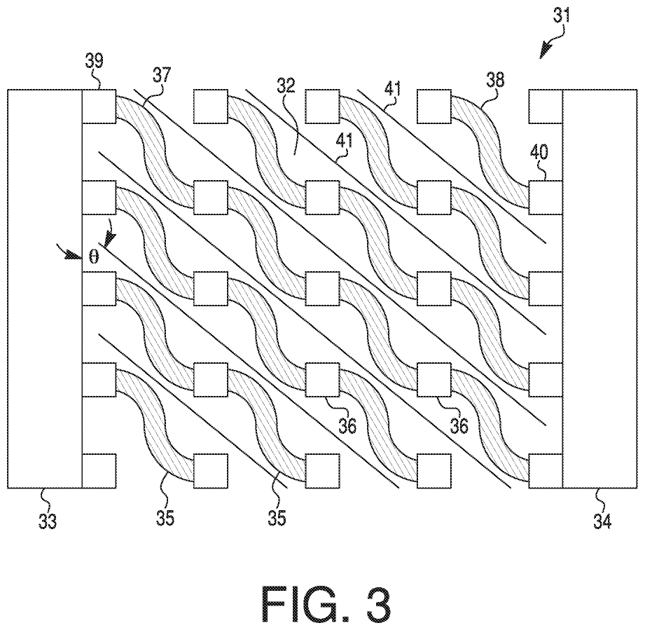

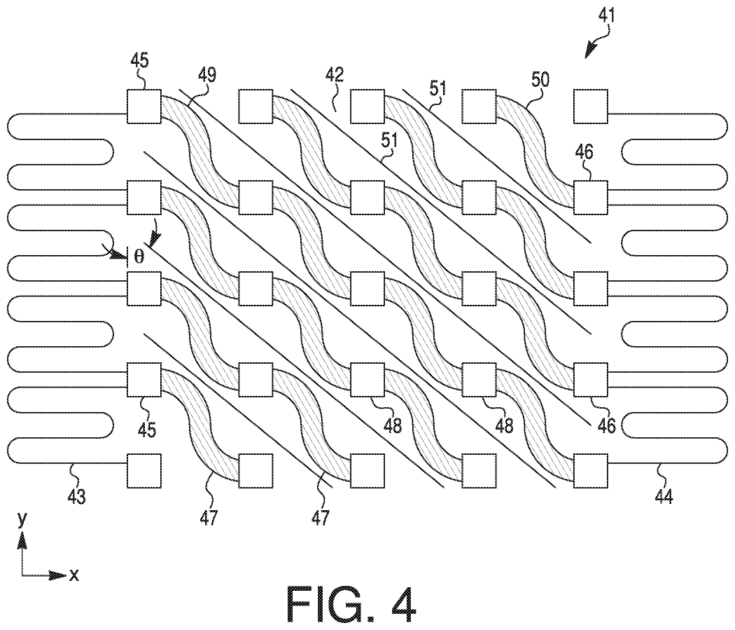

This configuration will be discussed further with reference to FIGS. 3 and 4. FIG. 3 illustrates a portion of an embodiment of a stretchable printed simple serpentine configuration heater 31 described above. The heater is printed on substrate 32. There are two parallel bus bars 33 and 34. The resistive material areas in the form of essentially identical serpentines 35 are arranged on parallel paths between the two bus bars with a space between adjacent parallel paths. The parallel paths make an angle θ with the bus bars. All printed resistive material serpentines on a path have the same orientation. There is a space between adjacent printed resistive material serpentines on a path, wherein in each path of printed resistive material serpentines a printed conductive material square 36 is positioned to fill the space between, to overlap, to be contiguous to and provide electrical contact with adjacent pairs of printed resistive material serpentines. In each path, the printed resistive material serpentine 37 adjacent to the one bus bar is in electrical contact with that bus bar and the printed resistive material serpentine 38 adjacent to the other bus bar is in electrical contact with that bus bar. In one embodiment, as shown in FIG. 3 these contacts with the bus bars are made through conductive material squares 39 and 40. Contacts could be made directly with the bus bars. Optionally slits 41 can be cut in the substrate to accommodate stretching and improve breathability.

Since FIG. 3 illustrates only a portion of the heater some of the paths of serpentines shown do not extend to both bus bars. In the actual heater all paths of serpentines would extend from one bus bar to the other bus bar.

The heater provides stretchability in the direction perpendicular to the two bus bars as well as oblique directions.

FIG. 4 illustrates a portion of another embodiment of a stretchable printed simple serpentine configuration heater 41. The heater is printed on substrate 42. The two bus bars 43 and 44 are in a wavelike form, an undulating conductor. Each of the bus bars is shown divided into separate portions that are connected by conductive material squares 45 and 46. The resistive material areas in the form of essentially identical serpentines 47 are arranged on parallel paths between the two bus bars with a space between adjacent parallel paths. As shown, the parallel paths make an angle θ with the bus bars. All printed resistive material serpentines on a path have the same orientation. There is a space between adjacent printed resistive material serpentines 47 on a path, wherein in each path of printed resistive material serpentines a printed conductive material square 48 is positioned to fill the space between, to overlap, to be contiguous to and provide electrical contact with adjacent pairs of printed resistive material serpentines. In each path, the printed resistive material serpentine 49 adjacent to bus bar 43 is in electrical contact with a conductive material square 45 that connects portions of that bus bar and the printed resistive material serpentine 50 adjacent to bus bar 44 is in electrical contact with a conductive material square 46 that connects portions of that bus bar. Optionally slits 51 can be cut in the substrate to accommodate stretching and also improve breathability.

Since FIG. 4 illustrates only a portion of the heater some of the paths of serpentines shown do not extend to both bus bars. In the actual heater all paths of serpentines would extend from one bus bar to the other bus bar.

The heater provides stretchability in the both the x and y directions and in oblique directions.

### Glide Reflection Serpentine Configuration

In this configuration, the heater comprises a substrate, two parallel printed bus bars and an array of printed resistive material areas in the form of serpentines with uniform thickness arranged on parallel paths between the two bus bars with a space between adjacent parallel paths. Each of the serpentines on a path can be generated by a repeated application of a glide reflection of a serpentine, wherein there is a space between adjacent printed resistive material serpentines on a path. In each path, the printed resistive material serpentine adjacent to the one bus bar is in electrical contact with that bus bar and the printed resistive material serpentine adjacent to the other bus bar is in electrical contact with that bus bar. The heater also comprises an array of printed conductive material areas, wherein in each path of printed resistive material serpentines a printed conductive material area is positioned to fill the space between, to overlap, to be contiguous to and provide electrical contact with adjacent pairs of printed resistive material serpentines. The conductive material areas and the bus bars can be printed onto the substrate before or after the resistive material.

The portions of the resistive material not in contact with the conductive areas or the bus bars provide the heating.

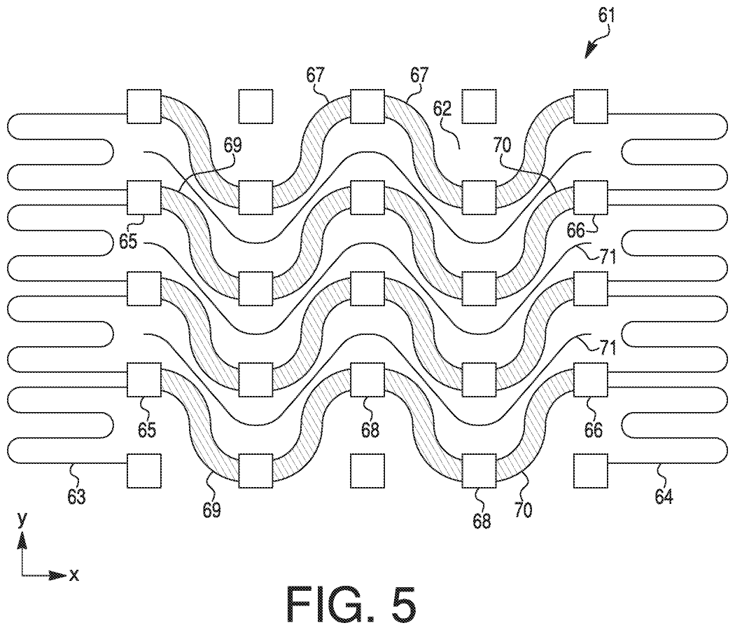

This configuration will be discussed further with reference to FIG. 5.

FIG. 5 illustrates a portion of an embodiment of a stretchable printed glide reflection serpentine configuration heater 61 described above. The heater is printed on substrate 62. The two bus bars 63 and 64 are in a wavelike form, an undulating conductor. Each of the bus bars is shown divided into separate portions that are connected by conductive material squares 65 and 66. The resistive material serpentines 67 are arranged on parallel paths between the two bus bars with a space between adjacent parallel paths. There is a space between adjacent printed resistive material serpentines 67 on a path, wherein in each path of printed resistive material serpentines a printed conductive material square 68 is positioned to fill the space between, to overlap, to be contiguous to and provide electrical contact with adjacent pairs of printed resistive material serpentines. In each path, the printed resistive material serpentine 69 adjacent to bus bar 63 is in electrical contact with a conductive material square 65 that connects portions of that bus bar and the printed resistive material serpentine 70 adjacent to bus bar 64 is in electrical contact with a conductive material square 66 that connects portions of that bus bar. Optionally slits 71 can be cut in the substrate to accommodate stretching and also improve breathability.

The heater provides stretchability in all directions.

### Criss-Cross Latticework Configuration

In this configuration, the heater comprises a substrate, two parallel printed bus bars and an array of printed resistive material areas in the form of essentially identical rectangles with uniform thickness arranged in a criss-cross latticework pattern of intersecting straight lines between the two bus bars. A printed resistive material rectangle is situated along each segment of the criss-cross latticework between intersections of the straight lines. There is a space between the four adjacent printed resistive material rectangles at each intersection. The resistive material rectangles adjacent to the one bus bar are in electrical contact with that bus bar and the resistive material rectangles adjacent to the other bus bar are in electrical contact with that bus bar. The heater also comprises an array of printed conductive material areas, wherein a printed conductive material area is positioned to fill the space between, to overlap, to be contiguous to and provide electrical contact with all four adjacent resistive material rectangles at every intersection. The conductive material areas and the bus bars can be printed onto the substrate before or after the resistive material rectangles.

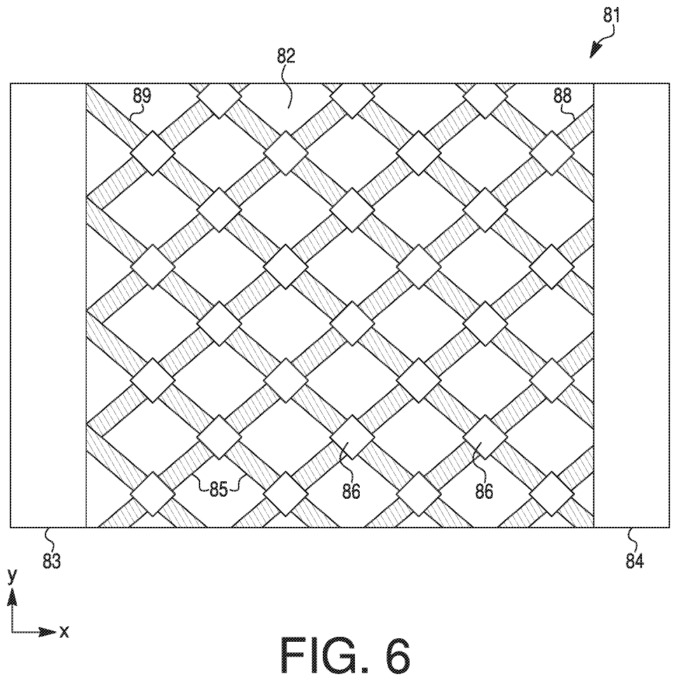

This configuration will be discussed further with reference to FIG. 6.

FIG. 6 illustrates a portion of an embodiment of a stretchable printed criss-cross latticework configuration heater 81 described above. The heater is printed on substrate 22. There are two parallel bus bars 83 and 84. The resistive material rectangles 85 are arranged in a criss-cross latticework pattern of intersecting straight lines between the two bus bars. A printed resistive material rectangle is situated along each segment of the criss-cross latticework between intersections of the straight lines. There is a space between the four adjacent printed resistive material rectangles at each intersection of the latticework, wherein a printed conductive material square 86 is positioned to fill the space between, to overlap, to be contiguous to and provide electrical contact with all four adjacent printed resistive material rectangles at every intersection. The printed resistive material rectangles 89 adjacent to bus bar 83 are in electrical contact with bus bar 83 and the printed resistive material rectangles 88 adjacent to bus bar 84 are in electrical contact with bus bar 84.

Since FIG. 6 illustrates only a portion of the heater some of the latticework does not extend to both bus bars. In the actual heater all paths of the latticework would extend from one bus bar to the other bus bar.

As depicted in FIG. 6 with the solid bus bars, this heater provides stretchability in the direction perpendicular to the two bus bars, i.e., the x direction and in oblique directions. However, if the solid bus bars were to be replaced with the wavelike form, i.e., the undulating bus bars as shown in FIGS. 4 and 5, the heater would provide stretchability in all directions.

What is claimed is:

1. An article containing a heater, the heater comprising:
a) a substrate;
b) two parallel printed bus bars;
c) an array of printed resistive material areas with uniform thickness arranged along a series of regular zigzags between the two bus bars, wherein each of the essentially same-shaped zigzags can be generated by a repeated application of a glide reflection of a line segment of length L making an angle a less than 90° with one of the bus bars, wherein a printed resistive material area is situated along each line segment, wherein the length I of each printed resistive material area is shorter than L so that there is a space between adjacent printed resistive material areas, wherein in each zigzag the resistive material area adjacent to the one bus bar is in electrical contact with that bus bar and the resistive material area adjacent to the other bus bar is in electrical contact with that bus bar, and wherein the zigzags are parallel to one another and there is a space between adjacent zigzags; and
d) an array of printed conductive material areas, wherein in each of the zigzags a printed conductive material area is positioned to fill the space between, to overlap, to be contiguous to and provide electrical contact with adjacent pairs of resistive material areas, and wherein the conductive material areas and the bus bars can be printed onto the substrate before or after the resistive material areas.

2. The article of claim 1, wherein the spaces between adjacent zigzags are the same size.

3. The article of claim 1, wherein the resistive material areas are in the form of essentially identical rectangles and the conductive material areas are in the form of essentially identical rectangles.

4. The article of claim 1, wherein the resistive material areas are in the form of essentially identical rectangles and the conductive material areas are in the form of essentially identical squares.

5. The article of claim 1, wherein the resistive material is carbon and the conductive material is silver.

6. The article of claim 1, wherein the resistive material is carbon and the conductive material is selected from the group consisting of silver/silver chloride, copper, gold and aluminum.

7. An article containing a stretchable printed heater, the heater comprising:
a) a substrate;
b) two parallel printed bus bars;
c) an array of printed resistive material areas in the form of serpentines with uniform thickness arranged on parallel paths between the two bus bars with a space between adjacent parallel paths, wherein the parallel paths are not perpendicular to the bus bars, wherein all printed resistive material serpentines on a path have the same orientation, wherein there is a space between adjacent printed resistive material serpentines on a path; and wherein in each path the printed resistive material serpentine adjacent to the one bus bar is in electrical contact with that bus bar and the printed resistive material serpentine adjacent to the other bus bar is in electrical contact with that bus bar; and
d) an array of printed conductive material areas, wherein in each path of printed resistive material serpentines a printed conductive material area is positioned to fill the space between, to overlap, to be contiguous to and provide electrical contact with adjacent pairs of printed resistive material serpentines, and wherein the conductive material areas and the bus bars can be printed onto the substrate before or after the resistive material areas.

8. The article of claim 7, wherein the spaces between adjacent parallel paths are the same size.

9. The article of claim 7, wherein the resistive material areas are in the form of essentially identical serpentines and the conductive material areas are in the form of essentially identical squares.

10. The article of claim 7, wherein the resistive material is carbon and the conductive material is silver.

11. The article of claim 7, wherein the bus bars have a wavelike form as illustrated in FIG. 4.

12. An article containing a stretchable printed heater, the heater comprising:
a) a substrate;
b) two parallel printed bus bars;
c) an array of printed resistive material areas in the form of serpentines with uniform thickness arranged on parallel paths between the two bus bars with a space between adjacent parallel paths, wherein each of the serpentines on a path can be generated by a repeated application of a glide reflection of a serpentine, wherein there is a space between adjacent printed resistive material serpentines on a path; and wherein in each path the printed resistive material serpentine adjacent to the one bus bar is in electrical contact with that bus bar and the printed resistive material serpentine adjacent to the other bus bar is in electrical contact with that bus bar; and
d) an array of printed conductive material areas, wherein in each path of printed resistive material serpentines a printed conductive material area is positioned to fill the space between, to overlap, to be contiguous to and provide electrical contact with adjacent pairs of printed resistive material serpentines, and wherein the conductive material areas and the bus bars can be printed onto the substrate before or after the resistive material.

13. The article of claim 12, wherein the spaces between adjacent parallel paths are the same size.

14. The article of claim 12, wherein the conductive material areas are in the form of squares.

15. The article of claim 12, wherein the resistive material is carbon and the conductive material is silver.

16. The article of claim 12, wherein the bus bars have a wavelike form as illustrated in FIG. 5.

17. An article containing a heater, the heater comprising:
a) a substrate;
b) two parallel printed bus bars;
c) an array of printed resistive material areas in the form of essentially identical rectangles of uniform thickness arranged in a criss-cross latticework pattern of intersecting straight lines between the two bus bars, wherein a printed resistive material rectangle is situated along each segment of the criss-cross latticework between intersections of the straight lines, wherein there is a space between adjacent printed resistive material rectangles at each intersection and wherein the resistive material rectangles adjacent to the one bus bar are in electrical contact with that bus bar and the resistive material rectangles adjacent to the other bus bar are in electrical contact with that bus bar; and
d) an array of printed conductive material areas, wherein a printed conductive material area is positioned to fill the space between, to overlap, to be contiguous to and provide electrical contact with all four adjacent resistive material rectangles at every intersection, and wherein the conductive material areas and the bus bars can be printed onto the substrate before or after the resistive material rectangles.

18. The article of claim 17, wherein the conductive material areas are in the form of essentially identical squares.

19. The article of claim 17, wherein the resistive material is carbon and the conductive material is silver.

20. The article of claim 17, wherein the bus bars have a wavelike form.
